(19) United States
(12) Patent Application Publication
(10) Pub. No.: US 2026/0302243 A1
(43) Pub. Date: Oct. 1, 2026

(54) SECONDARY BATTERY AND ELECTRONIC DEVICE

(71) Applicant: Ningde Amperex Technology Limited, Ningde (CN)

(72) Inventors: Guanyin ZENG, Ningde (CN); Bo FENG, Ningde (CN)

(73) Assignee: Ningde Amperex Technology Limited, Ningde (CN)

(21) Appl. No.: 19/573,182

(22) Filed: Mar. 20, 2026

(30) Foreign Application Priority Data
Mar. 25, 2025 (CN) 202510360632.7

(51) Int. Cl. H01M 4/62; H01M 4/02; H01M 4/13

(52) U.S. Cl. CPC H01M 4/623; H01M 4/13; H01M 2004/021; H01M 2004/027

(57) ABSTRACT

A secondary battery includes an electrode assembly with a wound structure, the electrode assembly includes a negative electrode sheet and a separator, the negative electrode sheet includes a current collector, a negative electrode material layer, and a bonding layer, and the negative electrode material layer is located between the negative electrode current collector and the bonding layer; the bonding layer includes a first and a second coating region, the first coating region and the second coating region is located in a flat region and a corner region of the electrode assembly, respectively. The first coating region and the second coating region include a first coating region material and a second coating region material, respectively. In a cross-section along a thickness direction of the bonding layer, an average short-axis size of particles of the first coating region material and the second coating region material is D1 and D2 μm, and 2≤D2/D1≤6.

### CROSS-REFERENCE TO RELATED APPLICATION

The present application claims priority to Chinese Patent Application No. 202510360632.7, filed on Mar. 25, 2025, the disclosure of which is hereby incorporated by reference in its entirety.

### TECHNICAL FIELD

The present application relates to the field of electrochemical technologies, and in particular, to a secondary battery and an electronic device.

### BACKGROUND

In recent years, with the growing demand for sustainable energy, the market demand for secondary batteries has also been increasing. Among them, secondary batteries with a wound structure are widely used due to their advantages such as high volumetric energy density, long cycle life, and ease of miniaturization. However, due to the structural characteristics of such secondary batteries with a wound structure, certain challenges remain in their application.

For example, a secondary battery with a wound structure is mainly divided into a flat region and a corner region. The corner region has limited electrolyte storage capacity, and during the cycling process of the secondary battery, insufficient electrolyte in the corner region leads to increased internal resistance. This makes the negative electrode sheet prone to problems such as lithium plating and black spots, impairing the cycling performance of the secondary battery.

### SUMMARY

The purpose of the present application is to provide a secondary battery and an electronic device to improve the cycling performance of the secondary battery.

It should be noted that in the summary of the invention of the present application, the present application is explained by taking a lithium-ion battery as an example of the secondary battery, but the secondary battery of the present application is not limited to lithium-ion batteries. The specific technical solutions are as follows:

A first aspect of the present application provides a secondary battery including an electrode assembly with a wound structure, where the electrode assembly includes a negative electrode sheet and a separator, and the negative electrode sheet includes a negative electrode current collector, a negative electrode material layer, and a bonding layer. Along a thickness direction of the negative electrode sheet, the negative electrode material layer is located between the negative electrode current collector and the bonding layer. The bonding layer includes a first coating region and a second coating region, where the first coating region is located in a flat region of the electrode assembly, and the second coating region is located in a corner region of the electrode assembly. The first coating region includes a first coating region material, the second coating region includes a second coating region material; and in a cross-section of the bonding layer along a thickness direction of the bonding layer, an average short-axis size of particles of the first coating region material is D1 μm, an average short-axis size of particles of the second coating region material is D2 μm, and 2≤D2/D1≤6. In this way, through the above arrangement, it helps to maintain the cycling performance and energy density of the flat region and the corner region of the secondary battery. The “average short-axis size” in the present application refers to the length of the short axis of elliptical particles, and when the particles exhibit irregular shapes, it is the diameter of the inscribed circle.

In some embodiments of the present application, 0.14≤D1≤0.7, and in some embodiments of the present application, 0.2≤D1≤0.5. By controlling D1 within the above ranges, it helps to improve the cycling performance of the secondary battery and maintain the energy density.

In some embodiments of the present application, 0.8≤D2≤1.50. In some embodiments of the present application, 1≤D2≤1.2. By controlling D2 within the above ranges, it helps to improve the electrolyte storage capacity of the corner region and maintain the kinetic performance, thereby mitigating the lithium plating and the formation of black spots, and consequently enhancing the cycling performance of the secondary battery.

In some embodiments of the present application, a coating weight of the first coating region is a mg/5000 mm², a coating weight of the second coating region is b mg/5000 mm², and (a+0.1)≤b≤(a+0.6). In some embodiments of the present application, (a+0.2)≤b≤(a+0.4). By controlling a and b within the ranges of the present application, it helps to further improve the kinetic performance and cycling performance of the secondary battery, and maintain the energy density.

In some embodiments of the present application, 0.7≤a≤1.2. By controlling a within the above range, it helps to better maintain the production process yield, kinetic performance, and cycling performance of the secondary battery.

In some embodiments of the present application, the first coating region material includes a first binder material and a second binder material, and the second coating region material includes a third binder material and a fourth binder material; where the first binder material and the third binder material each independently include at least one of methyl acrylate, octyl acrylate, polymethyl methacrylate, or isooctyl acrylate; and the second binder material and the fourth binder material each independently include at least one of styrene, acrylonitrile, or polyvinylidene fluoride; a mass ratio m1 of the first binder material to the second binder material is 1:(1.2 to 2.0); and a mass ratio m2 of the third binder material to the fourth binder material is 1:(1.5 to 4). By selecting the above first coating region material and second coating region material, and controlling m1 and m2 within the above ranges, it helps to reduce the internal resistance of the corner region, mitigate the lithium plating and the formation of black spots, and thus further improve the cycling stability of the secondary battery.

In some embodiments of the present application, the separator includes a base film and a composite layer disposed on one surface of the base film, where the composite layer faces the negative electrode sheet, the composite layer includes a ceramic material, and based on a mass of the composite layer, a mass percentage of the ceramic material is W2, 78%≤W2≤92%. By introducing the composite layer between the base film and the bonding layer, and controlling W2 within the above range, it helps to reduce the occurrence of separation between the head separator and the electrode sheet, reduce the internal resistance, mitigate the lithium plating and the formation of black spots, and further improve the production process yield and the kinetic performance of the secondary battery.

In some embodiments of the present application, the composite layer further includes a solid electrolyte; where, based on the mass of the composite layer, a mass percentage of the solid electrolyte is W1, 1%≤W1≤8%. In some embodiments of the present application, 3%≤W1≤6%. By controlling W1 within the above ranges, it helps to further reduce the internal resistance, and mitigate the phenomena such as the lithium plating and black spots in the corner region, thereby enhancing the kinetic performance and cycling performance of the secondary battery.

In some embodiments of the present application, the composite layer includes a third coating region and a fourth coating region, where the third coating region is located in the flat region of the electrode assembly, the fourth coating region is located in the corner region of the electrode assembly, an average particle size of the ceramic material in the third coating region is D3 nm, and an average particle size of the ceramic material in the fourth coating region is D4 nm. In some embodiments of the present application, 200≤D3≤500. In some embodiments of the present application, 300≤D3≤400. By controlling D3 within the above ranges, it helps to maintain the transmission rate of active ions and the thickness of the electrode assembly in the flat region, thereby maintaining the cycling performance and energy density of the secondary battery.

In some embodiments of the present application, 600≤D4≤800. In some embodiments of the present application, 650≤D4≤750. By controlling D4 within the above ranges, it helps to further improve the electrolyte storage capacity of the corner region, mitigate the lithium plating and the formation of black spots on the negative electrode sheet during the cycling process, and enhance the cycling performance of the secondary battery.

In some embodiments of the present application, a coating weight of the third coating region is c mg/5000 mm², and a coating weight of the fourth coating region is d mg/5000 mm²; (c+0.1)≤d≤(c+2). In some embodiments of the present application, (c+0.4)≤d≤(c+1.2). By controlling c and d within the above ranges, it helps to mitigate the lithium plating and the formation of black spots, maintain the internal resistance of the flat region and the corner region of the secondary battery, and thus enhance the overall kinetic performance and cycling performance of the secondary battery.

In some embodiments of the present application, 7≤c≤12. By controlling c within the above range, it helps to enhance the kinetic performance of the secondary battery. In addition, it also helps to keep the overall thickness of the secondary battery within an appropriate range, and maintain the energy density of the secondary battery.

In some embodiments of the present application, the secondary battery satisfies at least one of the following features: (1) the solid electrolyte includes at least one of lithium aluminum titanium phosphate, lithium lanthanum zirconium oxide, lithium lanthanum zirconium titanium oxide, or lithium lanthanum titanium oxide; (2) the ceramic material includes at least one of boehmite, alumina, magnesium hydroxide, or barium sulfate; or (3) based on a mass of the composite layer, a mass percentage of the ceramic material is W2, where 78%≤W2≤92%. The secondary battery satisfying at least one of the above features helps to further improve the transmission rate of active ions in the secondary battery, thereby reducing the internal resistance, mitigating the lithium plating and the formation of black spots, and enhancing the kinetic performance and cycling performance of the secondary battery.

A second aspect of the present application provides an electronic device including the secondary battery according to any of the foregoing embodiments.

### Beneficial Effects of the Present Application

The present application provides a secondary battery and an electronic device. By differentially setting the bonding layer with different average sizes in the flat region and the corner region of the electrode assembly with a wound structure, and 2≤D2/D1≤6, it helps to targetedly improve the electrolyte storage capacity of the corner region, mitigate the lithium plating and the formation of black spots on the negative electrode sheet during the cycling process, and enhance the cycling performance of the secondary battery. In addition, it also helps to reduce the impact on the overall thickness of the flat region of the electrode assembly with a wound structure, thereby reducing the impact on the thickness of the secondary battery, and maintaining the energy density.

Certainly, implementing any product or method of the present application does not necessarily need to achieve all the above advantages at the same time.

### DESCRIPTION OF THE DRAWINGS

In order to more clearly illustrate the technical solutions in the embodiments of the present application, the accompanying drawings needed in the description of the embodiments will be briefly introduced below. Obviously, the accompanying drawings in the following description are only some embodiments of the present application, and for those of ordinary skill in the art, other embodiments can also be obtained based on these drawings.

FIG. 1 is a schematic diagram of an electrode assembly with a wound structure according to an embodiment of the present application;

FIG. 2 is a schematic structural diagram of a negative electrode sheet along a thickness direction of the negative electrode sheet according to an embodiment of the present application;

FIG. 3 is a schematic diagram of a bonding layer according to an embodiment of the present application;

FIG. 4 is a schematic structural diagram of a separator along a thickness direction of the separator according to an embodiment of the present application; and

FIG. 5 is a schematic diagram of a composite layer according to an embodiment of the present application.

### DETAILED DESCRIPTION

The technical solutions in the present application will be clearly described below in conjunction with the embodiments of the present application and the drawings. Obviously, the described embodiments are only part of the embodiments of the present application, not all embodiments. All other embodiments obtained by those skilled in the art based on the present application fall within the scope of protection of the present application.

It should be noted that in the specific embodiments of the present application, the present application is explained by taking a lithium-ion battery as an example of the secondary battery, but the secondary battery of the present application is not limited to lithium-ion batteries. The specific technical solutions are as follows:

The corner region of a secondary battery with a wound structure usually has the problem of insufficient electrolyte storage, that is, insufficient “electrolyte storage capacity”, and is prone to lithium plating and black spots, thereby impairing the cycling performance of the secondary battery. To improve the electrolyte storage capacity of the corner region and thereby reduce the lithium plating and black spot problems in the corner region, a bonding layer with a larger particle size can be applied on the surface of the separator to provide space for electrolyte storage, thereby enhancing the cycling performance of the secondary battery. However, as the particle size of the overall bonding layer particles on the surface of the separator increases, the thickness of the main body of the secondary battery with a wound structure significantly increases, which will reduce the overall energy density of the secondary battery.

Based on the above problems, the present application provides a secondary battery and an electronic device, which can improve the electrolyte storage capacity of the corner region, and mitigate the lithium plating and the formation of black spots, thereby enhancing the cycling performance of the secondary battery. In addition, it can also reduce the impact on the thickness of the main body of the secondary battery with a wound structure, and maintain the energy density.

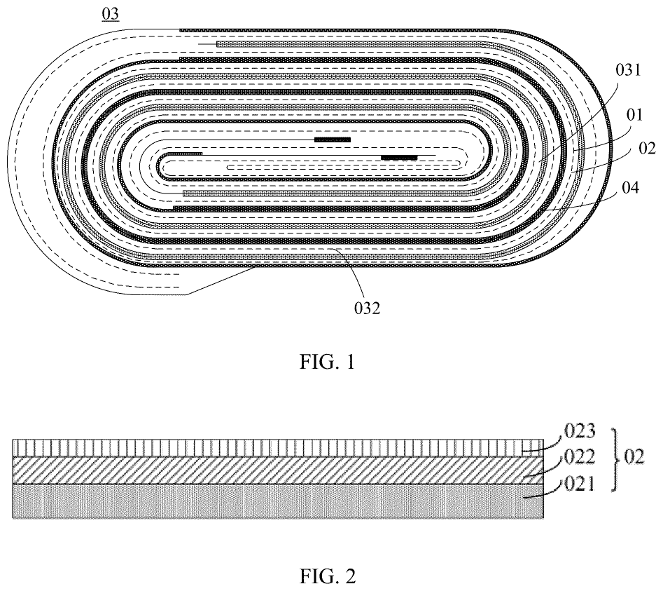

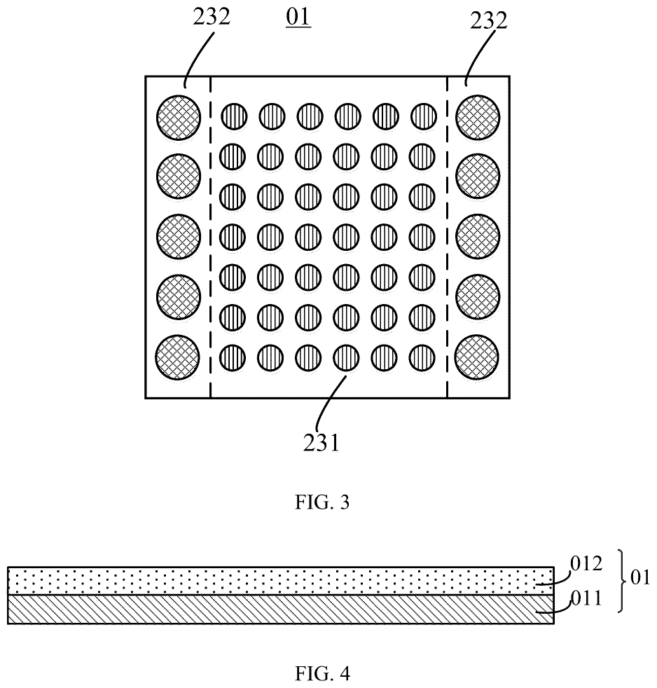

A first aspect of the present application provides a secondary battery, including an electrode assembly with a wound structure. The electrode assembly includes a negative electrode sheet and a separator, where the negative electrode sheet includes a negative electrode current collector, a negative electrode material layer, and a bonding layer, and along a thickness direction of the negative electrode sheet, the negative electrode material layer is located between the negative electrode current collector and the bonding layer. Specifically, as shown in FIG. 1 to FIG. 3, the electrode assembly 03 with a wound structure includes a negative electrode sheet 02, a positive electrode sheet 04, and a separator 01, where the negative electrode sheet 02 includes a negative electrode current collector 021, a negative electrode material layer 022, and a bonding layer 023, and the negative electrode material layer 022 and the bonding layer 023 are disposed on one surface of the negative electrode current collector 021; the bonding layer 023 includes a first coating region 231 and a second coating region 232, where the first coating region 231 is located in a flat region 032 of the electrode assembly 03, and the second coating region 232 is located in a corner region 031 of the electrode assembly 03. Compared to currently setting a bonding layer on the separator, the present application sets a bonding layer on the surface of the negative electrode material layer, which helps to reduce blockage of the separator, and improve the transmission of active ions such as lithium ions, thereby enhancing the kinetic performance of the secondary battery. It can be understood that the flat region of the secondary battery corresponds to the flat region of the electrode assembly, and the corner region of the secondary battery corresponds to the corner region of the electrode assembly. In some embodiments of the present application, the negative electrode material layer and the bonding layer may also be disposed on two surfaces of the negative electrode current collector, respectively.

The first coating region includes a first coating region material, the second coating region includes a second coating region material, and in a cross-section of the bonding layer along a thickness direction of the bonding layer, an average short-axis size of particles of the first coating region material is D1 μm, an average short-axis size of particles of the second coating region material is D2 μm, and 2≤D2/D1≤6. In some embodiments of the present application, 3≤D2/D1≤5. For example, D2/D1 may be 2, 2.2, 2.4, 2.6, 2.8, 3, 3.2, 3.4, 3.6, 3.8, 4, 4.2, 4.4, 4.6, 4.8, 5, 5.2, 5.4, 5.6, 5.8, 6, or in a range composed of any two of these ratios. When D2/D1 is too small, for example less than 2, it means that D2 is too small or D1 is too large, when D2 is too small, the second coating region cannot store enough electrolyte, and the corner region is still prone to lithium plating and black spot problems; when D1 is too large, it will cause the thickness of the flat region to be too large, impairing the energy density of the secondary battery. When D2/D1 is too large, for example greater than 6, it means that D2 is too large or D1 is too small, when D2 is too large, the active ion transmission distance is too long, and the internal resistance increases, thereby impairing the kinetic performance of the secondary battery; when D1 is too small, the pores between the first coating region materials decrease, impairing the transmission of active ions, and increasing the internal resistance, and the flat region is prone to the lithium plating and black spots. Therefore, by differentially setting the bonding layer with different average sizes on the negative electrode sheet in the flat region and the corner region of the electrode assembly with a wound structure, and 2≤D2/D1≤6, the first coating region material matches the second coating region material, which helps to targetedly improve the electrolyte storage capacity of the corner region, mitigate the lithium plating and the formation of black spots on the negative electrode sheet during the cycling process, and enhance the cycling performance of the secondary battery. In addition, it also helps to reduce the impact on the overall thickness of the flat region of the electrode assembly with a wound structure, thereby reducing the impact on the thickness of the secondary battery, and maintaining the energy density. In this way, through the above arrangement, it helps to maintain the cycling performance and energy density of the flat region and the corner region of the secondary battery. It should be noted that during the formation and hot pressing stage of the lithium-ion battery, the particles of raw materials for the first coating region material and the second coating region material usually deform under hot pressing. For example, after hot pressing a single particle of the first coating region material, its shape changes, the outer contour of the single particle has different sizes in two mutually perpendicular directions, usually elliptical or quasi-elliptical, its average short-axis size is usually smaller than the average particle size of its raw material particles, the average short-axis size is D1, and D2 is the same. For another example, particles formed by swelling or adhesion between two or more adjacent particles, its average short-axis size is usually larger than the average particle size of its raw material particles. It can be understood that the average short-axis size D1 of the particles of the first coating region material and the average short-axis size D2 of the particles of the second coating region material can be controlled by changing the pressure of formation and hot pressing in the preparation process of the lithium-ion battery. Exemplarily, when the pressure in the formation and hot pressing stage increases, D1 and D2 usually decrease; when the pressure in the formation and hot pressing stage decreases, D1 and D2 usually increase. The present application has no particular restriction on the temperature and pressure in the formation and hot pressing stage, as long as the purpose of the present application can be achieved. Exemplarily, the temperature in the formation and hot pressing stage is 70° C. to 80° C., and the pressure is 1.0 MPa to 1.8 MPa.

In some embodiments of the present application, the bonding layer is an aqueous bonding layer. The aqueous bonding layer in the present application is prepared by using water as a solvent to prepare an aqueous bonding layer slurry. Compared to other types of bonding layers, the aqueous bonding layer and the negative electrode sheet are usually prepared with water as a solvent in the preparation process, so the resulting negative electrode sheet has a better bonding effect with the aqueous bonding layer, which helps to mitigate the swelling phenomenon of the secondary battery after long cycle testing, and enhance the cycling performance of the secondary battery.

In some embodiments of the present application, 0.14≤D1≤0.7. In some embodiments of the present application, 0.2≤D1≤0.5. For example, D1 may be 0.14, 0.15, 0.2, 0.25, 0.3, 0.35, 0.4, 0.45, 0.5, 0.55, 0.6, 0.65, 0.7, or in a range composed of any two of these values. By controlling D1 within the above ranges, the particle size of the first coating region material is moderate, and thus the flat region of the resulting electrode assembly has an appropriate thickness. In addition, an appropriate D1 also facilitates the transmission of active ions in the flat region of the secondary battery, and thus D1 within the above ranges helps to enhance the cycling performance of the secondary battery and maintain the energy density.

In some embodiments of the present application, 0.8≤D2≤1.50. In some embodiments of the present application, 1≤D2≤1.2. For example, D2 may be 0.8, 0.85, 0.9, 0.95, 1, 1.05, 1.1, 1.15, 1.2, 1.25, 1.3, 1.35, 1.4, 1.45, 1.5 or in a range composed of any two of these values. By controlling D2 within the above ranges, it can store more electrolyte while promoting better transmission of active ions, thereby improving the electrolyte storage capacity of the corner region, maintaining the kinetic performance, reducing the lithium plating and the formation of black spots, and consequently enhancing the cycling performance of the secondary battery.

In some embodiments of the present application, a coating weight of the first coating region is a mg/5000 mm², a coating weight of the second coating region is b mg/5000 mm², and (a+0.1)≤b≤(a+0.6). In some embodiments of the present application, (a+0.2)≤b≤(a+0.4). By controlling a and b within the ranges of the present application, cooperating with the differentiated average sizes of the flat region and the corner region, it helps to improve the electrolyte storage capacity of the second coating region while enhancing the bonding force between the electrode sheet and the separator corresponding to the corner region, reducing the internal resistance, and further enhancing cycling performance. In addition, the first coating region also has a higher active ion transmission rate, and the thickness of the electrode assembly in the flat region is moderate, thereby enhancing the overall kinetic performance and cycling performance of the secondary battery, and maintaining the energy density.

In some embodiments of the present application, 0.7≤a≤1.2. For example, a may be 0.7, 0.72, 0.75, 0.78, 0.8, 0.82, 0.85, 0.88, 0.9, 0.95, 1.0, 1.02, 1.05, 1.08, 1.1, 1.12, 1.15, 1.18, 1.2, or in a range composed of any two of these values. By controlling a within the above range, the coating weights of the first coating region and the second coating region in the bonding layer are moderate, which facilitates the bonding between the negative electrode sheet and the separator, and also can provide channels for the transmission of active ions in the secondary battery, thereby better maintaining the production process yield, kinetic performance, and cycling performance of the secondary battery.

In some embodiments of the present application, 1.1≤b≤1.6. For example, b may be 1.1, 1.15, 1.2, 1.25, 1.3, 1.35, 1.4, 1.45, 1.5, 1.55, 1.6, or in a range composed of any two of these values.

In some embodiments of the present application, the first coating region material includes a first binder material and a second binder material, where the second coating region material includes a third binder material and a fourth binder material.

In some embodiments of the present application, the first binder material and the third binder material each independently include at least one of methyl acrylate, octyl acrylate, polymethyl methacrylate, or isooctyl acrylate. By selecting the above first binder material and/or third binder material, it helps to improve the viscosity of the first coating region material, thereby helping to reduce the internal resistance of the flat region of the secondary battery and enhance the kinetic performance and cycling stability of the secondary battery.

In some embodiments of the present application, the second binder material and the fourth binder material each independently include at least one of styrene, acrylonitrile, or polyvinylidene fluoride. By selecting the above second binder material and/or fourth binder material, it can play a supporting role in the bonding layer, such that the resulting bonding layer is less prone to melting and softening during the hot pressing process, thereby reserving channels for active ion transmission, reducing the lithium plating and the formation of black spots, and consequently helping to enhance the cycling performance of the secondary battery.

A mass ratio m1 of the first binder material to the second binder material is 1:(1.2 to 2.0). For example, m1 may be 1:2, 1:1.25, 1:1.3, 1:1.35, 1:4, 1:1.45, 1:1.5, 1:1.55, 1:1.6, 1:1.65, 1:1.7, 1:1.75, 1:1.8, 1:1.85, 1:1.9, 1:1.95, 1:2 or in a range composed of any two of these ratios. By selecting the first binder material and the second binder material with the above mass ratio, the resulting bonding layer has both good viscosity and appropriate support. This helps to improve the adhesion between the negative electrode sheet and the separator in the flat region, maintain channels for ion transmission, and reduce the internal resistance, thereby enhancing the kinetic performance and cycling performance of the secondary battery.

A mass ratio m2 of the third binder material to the fourth binder material is 1:(1.5 to 4). For example, m2 may be 1:1.5, 1:1.7, 1:2.0, 1:2.2, 1:2.6, 1:2.8, 1:3.0, 1:3.2, 1:3.4, 1:3.6, 1:3.8, 1:4 or in a range composed of any two of these ratios. By selecting the third binder material and the fourth binder material with the above mass ratio, the resulting bonding layer has both good viscosity and good support. This helps to reduce the internal resistance of the corner region and reduce the lithium plating black spots generated, thereby helping to further enhance the cycling stability of the secondary battery.

In some embodiments of the present application, as shown in FIG. 1 and FIG. 4, the separator 01 includes a base film 011 and a composite layer 012 disposed on one surface of the base film 011, where the composite layer 012 faces the negative electrode sheet 02. The composite layer includes a solid electrolyte and a ceramic material. Disposing the composite layer on the surface of the base film can provide channels for the transmission of active ions in the secondary battery, and even in the case of insufficient electrolyte in the corner region, the active ions can be transmitted through the solid electrolyte, reducing the internal resistance, reducing the lithium plating and the formation of black spots, and enhancing the kinetic performance and cycling performance of the secondary battery.

In some embodiments of the present application, based on a mass of the composite layer, a mass percentage of the ceramic material is W2, and 78%≤W2≤92%. For example, W2 may be 78%, 79%, 80%, 81%, 82%, 83%, 84%, 85%, 86%, 87%, 88%, 89%, 90%, 91%, 92% or in a range composed of any two of these values. By controlling W2 within the above range, it is beneficial for the composite layer to maintain a good active ion transmission rate while improving the electrolyte storage capacity of the corner region, thereby reducing the lithium plating and the formation of black spots, reducing the internal resistance, and further enhancing the kinetic performance and cycling performance of the secondary battery.

In some embodiments of the present application, based on the mass of the composite layer, a mass percentage of the solid electrolyte is W1, and 1%≤W1≤8%. In some embodiments of the present application, 3%≤W1≤6%. For example, W1 may be 1%, 1.5%, 2%, 2.5%, 3%, 3.5%, 4%, 4.5%, 5%, 5.5%, 6%, 6.5%, 7%, 7.5%, 8% or in a range composed of any two of these values. By controlling W1 within the above ranges, it helps to further reduce the internal resistance, and mitigate the phenomena such as the lithium plating and black spots in the corner region, thereby further enhancing the kinetic performance and cycling performance of the secondary battery.

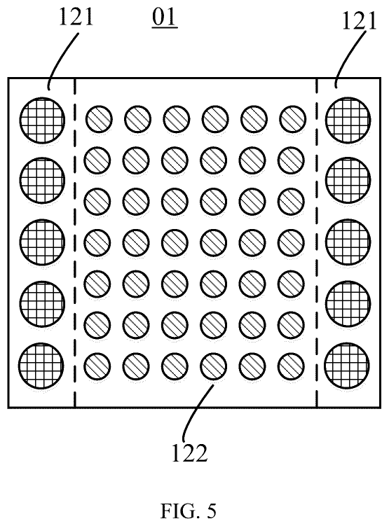

In some embodiments of the present application, as shown in FIG. 5, the composite layer 012 includes a third coating region 121 and a fourth coating region 122, where the third coating region 121 is located in the flat region 032 of the electrode assembly 03, and the fourth coating region 122 is located in the corner region 031 of the electrode assembly 03. An average particle size of the ceramic material in the third coating region is D3 nm, and an average particle size of the ceramic material in the fourth coating region is D4 nm.

In some embodiments of the present application, 200≤D3≤500. In some embodiments of the present application, 300≤D3≤400. For example, D3 may be 200, 220, 240, 260, 280, 300, 320, 340, 360, 380, 400, 420, 440, 460, 480, 500 or in a range composed of any two of these values. By controlling D3 within the above range, the average particle size of the ceramic material particles is moderate, which helps to maintain the transmission rate of active ions and the thickness of the electrode assembly in the flat region, thereby maintaining the cycling performance and energy density of the secondary battery.

In some embodiments of the present application, 600≤D4≤800. In some embodiments of the present application, 650≤D4≤750. For example, D4 may be 600, 610, 620, 630, 640, 650, 660, 670, 680, 690, 700, 710, 720, 730, 740, 750, 760, 770, 780, 790, 800 or in a range composed of any two of these values. By controlling D4 within the above range, the particle size of the ceramic material in the corner region is larger, which helps to further improve the electrolyte storage capacity of the corner region, mitigate the lithium plating and the formation of black spots on the negative electrode sheet during the cycling process, and enhance the cycling performance of the secondary battery.

In some embodiments of the present application, a coating weight of the third coating region is c mg/5000 mm², a coating weight of the fourth coating region is d mg/5000 mm²; and (c+0.1)≤d≤(c+2). In some embodiments of the present application, (c+0.4)≤d≤(c+1.2). By controlling c and d within the above ranges, differentially disposing the composite layer for the flat region and the corner region helps to further provide more channels for electron transmission in the corner region, mitigate the lithium plating and the formation of black spots in the corner region, and maintain the internal resistance of the flat region and the corner region of the secondary battery, thereby enhancing the overall kinetic performance and cycling performance of the secondary battery.

In some embodiments of the present application, 7≤c≤12. For example, c may be 7, 7.3, 7.6, 8, 8.2, 8.6, 9, 9.3, 9.5, 9.8, 10, 10.2, 10.4, 10.6, 10.8, 11, 11.2, 11.6, 11.8, 12 or in a range composed of any two of these values. By controlling c within the above ranges, it helps to improve the transmission rate of active ions, thereby enhancing the kinetic performance of the secondary battery. In addition, it also helps to keep the overall thickness of the secondary battery within an appropriate range, and maintain the energy density of the secondary battery.

In some embodiments of the present application, 7.1≤d≤14. In some embodiments of the present application, 10.1≤d1≤12. For example, d1 may be 7.1, 7.5, 8, 8.5, 9, 9.5, 10, 10.5, 11, 11.5, 12, 12.5, 13, 13.5, 14 or in a range composed of any two of these values.

In some embodiments of the present application, the solid electrolyte includes at least one of lithium aluminum titanium phosphate (Li_{1.5}Al_{0.5}Ti_{1.5}(PO₄)₃), lithium lanthanum zirconium oxide, lithium lanthanum zirconium titanium oxide, or lithium lanthanum titanium oxide. By selecting the above solid electrolyte, it helps to further increase the transmission rate of active ions in the secondary battery, thereby reducing the internal resistance, reducing the lithium plating and the formation of black spots, and enhancing the kinetic performance of the secondary battery.

In some embodiments of the present application, the ceramic material includes at least one of boehmite, alumina, magnesium hydroxide, or barium sulfate. The ceramic material has good heat resistance and electrochemical stability in the secondary battery, and can further improve the electrolyte storage capacity of the corner region, mitigate the lithium plating and the formation of black spots, and basically have no side reactions occurred, thereby further enhancing the cycling performance of the secondary battery.

In the present application, the technical features in the above embodiments can be combined arbitrarily, as long as the purpose of the present application can be achieved.

In some embodiments of the present application, the composite layer further includes a dispersant, a separator binder, and a wetting agent. The present application has no particular restriction on the types of the dispersant, the separator binder, and the wetting agent, as long as the purpose of the present application can be achieved. For example, the dispersant may include but is not limited to at least one of sodium carboxymethyl cellulose or lithium carboxymethyl cellulose. For example, the separator binder may include but is not limited to at least one of poly(methyl acrylate), poly(ethyl acrylate), poly(butyl acrylate), poly(octyl acrylate), poly(isooctyl acrylate), polyacrylic acid, sodium polyacrylate, potassium polyacrylate, lithium polyacrylate, polyimide, polyvinyl alcohol, carboxymethyl cellulose, polyimide, polyamide-imide, styrene-butadiene rubber, or polyvinylidene fluoride. For example, the wetting agent may include but is not limited to at least one of sodium dodecyl sulfate, sodium dodecylbenzenesulfonate, or sodium stearate.

The present application has no particular restriction on the content of the dispersant in the composite layer, as long as the purpose of the present application can be achieved. For example, based on the mass of the composite layer, a mass percentage of the dispersant is 0.5% to 1%. The present application has no particular restriction on the content of the separator binder in the composite layer, as long as the purpose of the present application can be achieved. For example, based on the mass of the composite layer, a mass percentage of the separator binder is 5% to 10%. The present application has no particular restriction on the content of the wetting agent in the composite layer, as long as the purpose of the present application can be achieved. For example, based on the mass of the composite layer, a mass percentage of the wetting agent is 1% to 3%.

The present application has no particular restriction on the preparation of the negative electrode sheet, as long as the purpose of the present application can be achieved. For example, when the bonding layer in the negative electrode sheet includes a first coating region and a second coating region, its preparation method includes but is not limited to the following steps:

First, the first binder material, the second binder material, and water are mixed to prepare a first coating region material slurry, then the third binder material, the fourth binder material, and solvent are mixed to prepare a second coating region material slurry; next, the corresponding coating weights of the first coating region material slurry and the second coating region material slurry are controlled respectively in the regions corresponding to the first coating region and the second coating region on one surface of the negative electrode sheet and dried, to obtain a negative electrode sheet with a bonding layer disposed on one side. Then the above steps are repeated on the other surface of the negative electrode sheet, to obtain a negative electrode sheet with bonding layers disposed on both sides.

The present application has no particular restriction on the solid content of the bonding layer slurry, as long as the purpose of the present application can be achieved.

The present application has no particular restriction on the method of setting the bonding layer slurry. For example, the bonding layer slurry can be disposed on the coating roller, and the pattern of the coating roller can be set according to the requirements for the coating region, such as adjusting the size of the coating region by adjusting the line width and line spacing in the line groove. As the coating roller rotates and comes into contact with the base film, the bonding layer slurry is applied on the base film. The coating weight can be controlled by modifying the load of the bonding layer on the coating roller. A larger load results in a higher coating weight, and vice versa.

The present application has no particular restriction on the preparation of the separator, as long as the purpose of the present application can be achieved. For example, when the composite layer in the separator includes a third coating region and a fourth coating region, its preparation method includes but is not limited to the following steps:

First, the solid electrolyte, the ceramic material, the dispersant, the separator binder, and the solvent are mixed to prepare a composite layer slurry, then the corresponding coating weights of the composite layer slurry are controlled respectively in the regions corresponding to the third coating region and the fourth coating region on one surface of the base film and dry, to obtain a separator with a composite layer set on one side. The present application has no particular restriction on the type of the solvent, as long as the purpose of the present application can be achieved. For example, the solvent may include at least one of water, acetone, or N-methylpyrrolidone (NMP). The present application has no particular restriction on the solid content of the composite layer slurry, as long as the purpose of the present application can be achieved. It can be understood that the ceramic material has high hardness, and its average particle size does not change significantly during the preparation of the secondary battery.

The present application has no particular restriction on the method of setting the composite layer, for example, it can be the above method of setting the bonding layer.

In the present application, the negative electrode sheet further includes a negative electrode current collector, and the negative electrode material layer is disposed on at least one surface of the negative electrode current collector. The above “negative electrode material layer disposed on at least one surface of the negative electrode current collector” means that the negative electrode material layer may be disposed on one surface of the negative electrode current collector along a thickness direction of the negative electrode current collector, or may be disposed on two surfaces of the negative electrode current collector along a thickness direction of the negative electrode current collector. It should be noted that the “surface” herein may be the entire region of the negative electrode current collector surface, or may be a portion of the region of the negative electrode current collector surface. The present application has no particular restriction, as long as the purpose of the present application can be achieved.

The present application has no particular restriction on the negative electrode current collector, as long as the purpose of the present application can be achieved. For example, it may include copper foil, copper alloy foil, nickel foil, stainless steel foil, titanium foil, nickel foam, copper foam, or composite current collector. Exemplarily, the composite current collector may be lithium copper composite current collector, carbon copper composite current collector, nickel copper composite current collector, titanium copper composite current collector, or the like.

The negative electrode material layer includes a negative electrode active material. The present application has no particular restriction on the negative electrode active material, as long as the purpose of the present application can be achieved. For example, the negative electrode active material may include but is not limited to at least one of natural graphite, artificial graphite, mesophase microcarbon spheres, hard carbon, soft carbon, silicon, silicon-carbon composite, Li—Sn alloy, Li—Sn—O alloy, Sn, SnO, SnO₂, spinel structure lithiated TiO₂—Li₄T₁₅O₁₂, or Li—Al alloy.

In some embodiments of the present application, the negative electrode material layer may further include a conductive agent and a negative electrode binder. The present application has no particular restriction on the types of conductive agent and negative electrode binder, as long as the purpose of the present application can be achieved. For example, the conductive agent may include but is not limited to at least one of conductive carbon black (Super P), carbon nanotubes (CNTs), carbon fibers, flake graphite, graphene, metal materials, or conductive polymers. The conductive carbon black may include but is not limited to at least one of acetylene black or Ketjen black. The carbon nanotubes may include but are not limited to single-walled carbon nanotubes and/or multi-walled carbon nanotubes. The carbon fibers may include but are not limited to vapor grown carbon fibers (VGCF) and/or nano carbon fibers. The metal materials may include but are not limited to metal powder and/or metal fibers. Specifically, the metal may include but is not limited to at least one of copper, nickel, aluminum, or silver. The above conductive polymers may include but are not limited to at least one of polyphenylene derivatives, polyaniline, polythiophene, polyacetylene, or polypyrrole. For example, the negative electrode binder may be at least one of the above separator binders. The present application has no particular restriction on the mass ratio of negative electrode active material, conductive agent, negative electrode binder in the negative electrode material layer, those skilled in the art can choose according to actual needs, as long as the purpose of the present application can be achieved.

The present application has no particular restriction on the thickness of the negative electrode material layer, as long as the purpose of the present application can be achieved. For example, a thickness of the negative electrode material layer is 30 μm to 120 μm.

The present application has no particular restriction on the thickness of the negative electrode current collector, as long as the purpose of the present application can be achieved. For example, a thickness of the negative electrode current collector is 4 μm to 15 μm.

Optionally, the negative electrode sheet may further include a conductive layer, where the conductive layer is located between the negative electrode current collector and the negative electrode material layer. The present application has no particular restriction on the composition of the conductive layer, which can be a conductive layer commonly used in the art. For example, the conductive layer includes a conductive agent and a negative electrode binder. The present application has no particular restriction on the conductive agent and negative electrode binder in the conductive layer, for example, it may be at least one of the above conductive agents and the above separator binders.

The present application has no particular restriction on the material of the base film, as long as the purpose of the present application can be achieved. For example, the material of the base film may include but is not limited to at least one of polyethylene (PE), polyolefin (PO) mainly based on polypropylene (PP), polyester (for example, polyethylene terephthalate (PET) film), cellulose, polyimide (PI), polyamide (PA), spandex, or aramid. The type of separator may include at least one of woven film, non-woven film, microporous film, composite film, rolled film, or spun film. The present application has no particular restriction on the thickness of the base film, as long as the purpose of the present application can be achieved. For example, a thickness of the base film may be 3 μm to 20 μm.

In the present application, the thickness of the separator is not particularly restricted, as long as the purpose of the present application can be achieved. For example, a thickness of the separator may be 5 μm to 30 μm.

In the present application, the secondary battery further includes a positive electrode sheet, where the positive electrode sheet includes a positive electrode current collector and a positive electrode material layer disposed on at least one surface of the positive electrode current collector. The above “positive electrode material layer disposed on at least one surface of the positive electrode current collector” means that the positive electrode material layer may be disposed on one surface of the positive electrode current collector along a thickness direction of the positive electrode current collector, or may be disposed on two surfaces of the positive electrode current collector along a thickness direction of the positive electrode current collector. It should be noted that the “surface” herein can be the entire region of the positive electrode current collector surface, or a portion of the region of the positive electrode current collector surface. The present application has no particular restriction, as long as the purpose of the present application can be achieved.

The present application has no particular restriction on the positive electrode current collector, as long as the purpose of the present application can be achieved. For example, it may include aluminum foil, aluminum alloy foil, composite current collector (for example, aluminum carbon composite current collector), or the like.

The positive electrode material layer includes a positive electrode active material. The present application has no particular restriction on the positive electrode active material, as long as the purpose of the present application can be achieved. For example, the positive electrode active material may include but is not limited to at least one of lithium nickel cobalt manganese oxide (for example NCM811, NCM622, NCM523, NCM111), lithium nickel cobalt aluminate, lithium iron phosphate, lithium-rich manganese-based material, lithium cobalt oxide (LiCoO₂), lithium manganese oxide, lithium manganese iron phosphate, or lithium titanate.

The positive electrode material layer may further include a conductive agent and a positive electrode binder. The present application has no particular restriction on the types of the conductive agent and the positive electrode binder, as long as the purpose of the present application can be achieved. For example, it may be at least one of the above conductive agents and the above separator binders. The present application has no particular restriction on the mass ratio of positive electrode active material, conductive agent, positive electrode binder in the positive electrode material layer, those skilled in the art can choose according to actual needs, as long as the purpose of the present application can be achieved.

The present application has no particular restriction on the thicknesses of the positive electrode current collector and the positive electrode material layer, as long as the purpose of the present application can be achieved. For example, the thickness of the positive electrode current collector is 5 μm to 20 μm, and the thickness of the positive electrode material layer is 30 μm to 120 μm.

Optionally, the positive electrode sheet may further include a conductive layer, where the conductive layer is located between the positive electrode current collector and the positive electrode material layer. The composition of the conductive layer is not particularly restricted, and can be a conductive layer commonly used in the art. The conductive layer includes a conductive agent and a positive electrode binder. The present application has no particular restriction on the conductive agent and positive electrode binder in the conductive layer, which may be, for example, at least one of the above conductive agents and the above separator binders.

In the present application, the secondary battery further includes an electrolyte, where the electrolyte includes a lithium salt and a non-aqueous solvent.

The present application has no particular restriction on the lithium salt, as long as the purpose of the present application can be achieved. For example, the lithium salt may include but is not limited to at least one of LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, Li₂SiF₆, lithium bis(oxalate)borate (LiBOB), or lithium difluoroborate. The present application has no particular restriction on the content of the lithium salt in the electrolyte, as long as the purpose of the present application can be achieved.

The present application has no particular restriction on the non-aqueous solvent, as long as the purpose of the present application can be achieved. For example, the non-aqueous solvent may include but is not limited to at least one of carbonate compounds, carboxylate compounds, ether compounds, or other organic solvents.

The carbonate compounds may include but are not limited to at least one of linear carbonate compounds, cyclic carbonate compounds, or fluorinated carbonate compounds. The linear carbonate compounds may include but are not limited to at least one of dimethyl carbonate (DMC), diethyl carbonate (DEC), dipropyl carbonate (DPC), methyl propyl carbonate (MPC), ethyl propyl carbonate (EPC), or methyl ethyl carbonate (MEC). The cyclic carbonates may include but are not limited to at least one of ethylene carbonate (EC), propylene carbonate (PC), butylene carbonate (BC), or vinyl ethylene carbonate (VEC). The fluorinated carbonate compounds may include but are not limited to at least one of fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, or trifluoromethyl ethylene carbonate. The carboxylate compounds may include but are not limited to at least one of methyl formate, methyl acetate, ethyl acetate, n-propyl acetate, tert-butyl acetate, methyl propionate, ethyl propionate, propyl propionate, γ-butyrolactone, decanolide, valerolactone, or caprolactone. The ether compounds may include but are not limited to at least one of dibutyl ether, tetraglyme, diglyme, 1,2-dimethoxyethane, 1,2-diethoxyethane, 1-ethoxy-1-methoxyethane, 2-methyltetrahydrofuran, or tetrahydrofuran. The above other organic solvents may include but are not limited to at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate. The present application has no particular restriction on the content of the non-aqueous solvent in the electrolyte, as long as the purpose of the present application can be achieved.

The secondary battery further includes a housing for accommodating the positive electrode sheet, the separator, the negative electrode sheet, and the electrolyte, as well as other components known in the field of secondary batteries, the present application does not limit the above other components. The present application has no particular restriction on the housing, which can be a housing known in the art, as long as the purpose of the present application can be achieved. For example, the housing may be a hard shell housing or a flexible housing. The material of the hard shell housing may be metal, the present application does not limit the type of metal, and known metal hard shell housings in the art can be used, as long as the purpose of the present application can be achieved. The flexible housing may be a metal plastic film, such as aluminum plastic film or steel plastic film.

The preparation process of the secondary battery of the present application is well known to those skilled in the art, and the present application has no particular restriction thereon. For example, the preparation process of the secondary battery may include but is not limited to the following steps: the positive electrode sheet, the separator, the negative electrode sheet, and the separator are stacked in order, and then wound, folded, as needed to obtain an electrode assembly with a wound structure, the electrode assembly is placed into the housing, the electrolyte is injected into the housing, and sealing the housing is performed, to obtain the secondary battery. When the separator includes a composite layer, the side with the composite layer is disposed facing the negative electrode sheet. In addition, overcurrent protection elements, guide plates, and the like can also be placed in the housing as needed to prevent pressure rise and overcharge-discharge inside the secondary battery.

A second aspect of the present application provides an electronic device including the secondary battery according to any of the foregoing embodiments. Thus, the electronic device provided by the present application has good service performance.

The present application has no particular limitation on the type of electronic device, which can be any electronic device known in the prior art. In some embodiments of the present application, the electronic device may include but is not limited to notebook computers, pen-input computers, mobile computers, e-book players, portable phones, portable fax machines, portable copiers, portable printers, head-mounted stereo headphones, video recorders, liquid crystal televisions, portable cleaners, portable CD players, mini discs, transceivers, electronic notepads, calculators, memory cards, portable recorders, radios, backup power supplies, motors, automobiles, motorcycles, power-assisted bicycles, bicycles, lighting fixtures, toys, game consoles, clocks, power tools, flashlights, cameras, large household storage batteries, and lithium-ion capacitors.

### EXAMPLES

Below, examples and comparative examples are given to more specifically illustrate the embodiments of the present application. Various tests and evaluations are carried out according to the following methods. In addition, unless otherwise specified, “parts” and “%” are on a mass basis.

### Test Methods and Equipment:

### Sampling of Negative Electrode Sheet and Separator:

First, the lithium-ion battery was disassembled, the negative electrode sheet and the separator were taken out and cleaned with dimethyl carbonate (DMC), the negative electrode sheet at 80° C. was then dried to obtain a negative electrode sheet sample; and the separator was air-dried at room temperature to obtain a separator sample.

Unless otherwise specified in the following test methods, the tests are carried out using the above obtained negative electrode sheet sample and separator sample.

### Average Short-Axis Size D1 of Particles of First Coating Region Material, Average Short-Axis Size D2 of Particles of Second Coating Region Material:

A negative electrode sheet sample corresponding to the flat region of the electrode assembly was taken. The cross-section of the negative electrode sheet along the thickness direction was ion-polished to obtain the cross-section of the negative electrode sheet, which was then measured under a scanning electron microscope (SEM). Combined with the elemental analysis function of the SEM, a region free of metal elements was selected. Subsequently, 10 particles without metal elements were selected from this region, their short-axis sizes were tested respectively, and the average value was calculated, which is D1.

Then a negative electrode sheet sample corresponding to the corner region of the electrode assembly was taken, and D2 was measured using the same method as above.

### Average Particle Size D3 of Ceramic Particles in Third Coating Region, Average Particle Size D4 of Ceramic Particles in Fourth Coating Region:

A separator sample was taken from the overhang region (overhang region) extending beyond the electrode sheet and corresponding to the flat region of the electrode assembly. The cross-section of the separator sample along the thickness direction was ion-polished to obtain the cross-section of the separator, which was then measured under a scanning electron microscope (SEM). Combined with the elemental analysis function of the SEM, 10 particles containing metal elements but no transition metal elements were selected, their inscribed circle diameters were tested respectively, and the average value was calculated, which is D3.

Then a separator sample corresponding to the corner region of the electrode assembly was taken, and D4 was measured using the same method as above.

### Coating Weight c of Third Coating Region, Coating Weight d of Fourth Coating Region:

A separator sample was taken from the overhang region (overhang region) extending beyond the electrode sheet and corresponding to the flat region of the electrode assembly. The sample was cut into a piece with an area of s mm², and tested using a thermogravimetric-mass spectrometry (TGA-MS) instrument. The test parameters were set as follows: initial temperature of 25° C., final temperature of 450° C., and heating rate of 5° C./min. The test was performed in an air atmosphere, and the mass-temperature curve was recorded. The total mass loss u3 at 180° C. corresponds to the mass of the dispersant, binder, and wetting agent in the composite layer, and the final remaining mass of the sample was recorded as the mass u4 mg of the composite layer.

$$coating weight of the composite layer = ( u 3 + u 4 ) / s \times 500 \; 0 .$$

### Energy Density:

A three-dimensional scanner was used to measure the length L, width W, and thickness H of the battery.

At an ambient temperature of 25° C., the lithium-ion battery was charged at a constant current of 0.2C to a voltage of 4.5 V on a charge-discharge tester, then charged at the constant voltage of 4.5 V to a cutoff current of 0.05C, left standing for 10 min, and then discharged at a constant current of 0.2C to 3 V. The discharge capacity C and discharge platform V were recorded, and thus the volumetric energy density VED of the lithium-ion battery was =(C×V)/(L×W×H), in a unit of Wh/L.

### 0° C._1.5C_Lithium Plating Test:

The lithium-ion battery was placed in a 10° C. environment, charged at a constant current of 1.5C to a voltage of 4.5 V, then charged at the constant voltage of 4.5 V to a cutoff current of 0.05C, left standing for 5 min, discharged at a constant current of 0.5C to a voltage of 3.0 V, and left standing for 5 min. The above process constituted one charge-discharge cycle. Then 10 cycles of charging and discharging was carried out with the same steps.

Then the lithium-ion battery was charged at a constant current of 1.5C to 4.5 V, then charged at the constant voltage of 4.5 V to a cutoff current of 0.05C, left standing for 5 min. Then the lithium-ion battery was disassembled, the surface of the negative electrode sheet adjacent to the separator was determined as the observation interface.

The 0° C._1.5C_lithium plating test was used to characterize the kinetic performance of the lithium-ion battery.

### Interface Observation:

The surface interface of the negative electrode sheet was observed to determine whether it was uniformly “golden yellow”. If there were gray-white bright spots, it was recorded as “lithium plating”; if no gray-white metallic lithium was precipitated, it was recorded as “no lithium plating”; if gray-white metallic lithium was precipitated and the lithium plating area ratio was less than 5%, it was recorded as “slight lithium plating”; if gray-white metallic lithium was precipitated and the lithium plating area ratio was greater than or equal to 5%, it was recorded as “severe lithium plating”. Herein, the lithium plating area ratio referred to the percentage of the lithium plating area relative to the observation interface area of the negative electrode sheet. The observation interface was the same as that specified in the “0° C._1.5C_lithium plating test” method.

### Cycle Capacity Retention Rate:

At 25° C., the lithium-ion battery was charged at a constant current of 2.0C to a voltage of 4.5 V, then charged at the constant voltage of 4.5 V until the current dropped to 0.05C, and left standing for 10 minutes. Subsequently, the battery was discharged at a constant current of 1C to a voltage of 3.0 V, and left standing for 5 minutes. The above process constituted one cycle. The cycle was repeated up to 800 times, the discharge capacity of the first cycle was recorded as the initial capacity Q0, and the discharge capacity of the lithium-ion battery at the 800th cycle was recorded as Q1. The cycle capacity retention rate of the lithium-ion battery at the 800th cycle was calculated using the following formula: Cycle Capacity Retention Rate (%)=Q1/Q0×100%.

### Cycle Thickness Swelling Rate:

At 25° C., the lithium-ion battery was charged at a constant current of 0.2C to a voltage of 4.5 V, then charged at the constant voltage of 4.5 V until the current dropped to 0.05C to reach a fully charged state, and the thickness of the lithium-ion battery at this time was recorded as H1. Subsequently, the battery was discharged at a constant current of 1C to a voltage of 3.0 V, and left standing for 5 minutes. The above process constituted one cycle. The cycle was repeated up to 800 times, then the lithium-ion battery was charged to a fully charged state according to the aforementioned method, and its thickness was tested as H2.

$$cycle thickness swelling rate = ( H 2 - H 1 ) / H 1 \times 100 \% .$$

### Example 1-1

### <Preparation of Positive Electrode Sheet>

A positive electrode active material lithium cobalt oxide, a conductive agent conductive carbon black (Super P), and a positive electrode binder (polyvinylidene fluoride) were mixed at a mass ratio of 97.9:0.9:1.2. N-methylpyrrolidone (NMP) was added as the solvent to prepare a slurry with a solid content of 75 wt %. After uniform stirring under vacuum, the positive electrode slurry was obtained. The positive electrode slurry was evenly applied on one surface of a 10 μm-thick positive electrode current collector aluminum foil and dried at 120° C., yielding a positive electrode sheet with a single-sided positive electrode material layer. The coating weight of the positive electrode material layer was 267.8 mg/1540 mm². Subsequently, the above steps were repeated on the other surface of the aluminum foil, resulting in a positive electrode sheet with double-sided positive electrode material layers. After drying at 120° C., the sheet was cold-pressed, followed by cutting and tab welding. A positive electrode sheet with dimensions of 74 mm×867 mm was finally obtained for subsequent use. The thickness of the single-sided positive electrode material layer was 42 μm.

### <Preparation of Negative Electrode Sheet>

Bonding layer slurry: A first binder material methyl acrylate and a second binder material styrene were mixed uniformly in water as the solvent at a mass ratio m1 of 1:1.5, yielding a first coating region material slurry with a solid content of 20 wt %. Subsequently, the third binder material (methyl acrylate) and the fourth binder material (styrene) were mixed uniformly in water as the solvent at a mass ratio m2 of 1:2.7, resulting in a second coating region material slurry with a solid content of 25 wt %.

A negative electrode active material artificial graphite, a negative electrode binder styrene-butadiene rubber, and a conductive agent acetylene black were mixed at a mass ratio of 97.4:1.4:1.2. Deionized water was added as the solvent to prepare a slurry with a solid content of 45 wt %. After being uniformly stirred in a vacuum mixer, the negative electrode slurry was obtained.

The negative electrode slurry was uniformly applied on one surface of a 6 μm-thick negative electrode current collector copper foil and dried at 120° C., obtaining a negative electrode sheet with a single-sided negative electrode material layer. The coating weight of the negative electrode material layer was 142 mg/1540 mm². Then, on one surface of the negative electrode material layer, the first coating region material slurry was applied to the region corresponding to the first coating region with a coating weight of a mg/5000 mm²=0.9 mg/5000 mm²; the second coating region material slurry was applied to the region corresponding to the second coating region on the same surface with a coating weight of b mg/5000 mm²=1.2 mg/5000 mm². After drying, a negative electrode sheet with a single-sided bonding layer was obtained. Subsequently, the above steps were repeated on the other surface of the copper foil, resulting in a negative electrode sheet with double-sided bonding layers. After drying at 120° C., the sheet was cold-pressed, followed by cutting and tab welding. A negative electrode sheet with dimensions of 78 mm×875 mm was finally obtained for subsequent use. The thickness of the single-sided negative electrode material layer was 54.5 μm. In the raw materials of the first coating region material, the average particle sizes of particles of the first binder material and particles of the second binder material were the same, both being 0.7 μm. In the raw materials of the second coating region material, the average particle sizes of particles of the third binder and particles of the fourth binder were the same, both being 4 μm.

### <Preparation of Electrolyte>

In an environment with a water content of less than 10 ppm, dimethyl carbonate, diethyl carbonate, and ethylene carbonate were mixed at a mass ratio of 1:1:1 to obtain an organic solvent. The electrolyte salt LiPF₆ was then added to the organic solvent, and the mixture was stirred uniformly to obtain the electrolyte. Based on the mass of the electrolyte, the mass percentage of the electrolyte salt was 12.5%, with the remainder being the organic solvent.

### <Separator>

Composite layer slurry: A ceramic material boehmite with an average particle size of 350 nm, a dispersant sodium carboxymethyl cellulose, a binder styrene-butadiene rubber, and a wetting agent sodium dodecyl sulfate were mixed uniformly in water as the solvent at a mass ratio of 92:0.8:6:1.2, yielding a third coating region composite layer slurry with a solid content of 30 wt %. Subsequently, a ceramic material boehmite with an average particle size of 700 nm was mixed uniformly following the aforementioned method, resulting in a fourth coating region composite layer slurry with a solid content of 30 wt %.

A 5 μm-thick polyethylene base film was used as the base film of the separator. The composite layer slurry was applied to the region corresponding to the third coating region on one surface of the base film with a coating weight of c mg/5000 mm²=10 mg/5000 mm², and the composite layer slurry was applied to the region corresponding to the fourth coating region on the same surface with a coating weight of d mg/5000 mm²=11 mg/5000 mm². The coated base film was then dried. The thickness of the composite layer was 1.5 μm, and the porosity of the separator was 39%. Specific parameters are shown in Tables 1 to 2.

### <Preparation of Lithium-Ion Battery>

The positive electrode sheet, the separator, the negative electrode sheet, and the separator prepared as above were stacked in sequence, with the separators positioned between the positive electrode sheet and the negative electrode sheet to serve as insulators. The stacked assembly was wound to obtain an electrode assembly with a wound structure. The electrode assembly was placed into an aluminum-plastic film packaging bag, and moisture was removed at 80° C. The electrolyte prepared above was injected into the bag, and the lithium-ion battery was finally obtained through processes including vacuum sealing, standing, formation, degassing, and edge trimming. The formation parameters were as follows: upper limit voltage of 4.15 V, formation temperature of 70° C., formation hot-pressing pressure of 1.5 MPa, formation time of 0.5 h, and formation standing time of 2 h.

### Example 1-2 to Example 1-20

Except for adjusting relevant preparation parameters according to Table 1, the rest are the same as Example 1-1. Examples 1-1 to 1-12 make D1 and D2 as shown in Table 1 by changing the pressure of formation and hot pressing in the preparation process of the lithium-ion battery.

### Example 1-21 to Example 1-30

Except for adjusting relevant preparation parameters according to Table 2, the rest are the same as Example 1-1.

### Example 2-1 to Example 2-9

Except for adjusting relevant preparation parameters according to Table 3, the rest are the same as Example 1-1.

### Example 2-10 to Example 2-28

Except for adjusting relevant preparation parameters according to Table 4, the rest are the same as Example 1-1.

### Comparative Example 1 to Comparative Examples 5

Except for adjusting relevant preparation parameters according to Table 1, the rest are the same as Example 1-1.

TABLE 1

| | | | | | | | | Cycle | Cycle | |
|---|---|---|---|---|---|---|---|---|---|---|
| | | | | a | b | Lithium | Lithium | capacity | thickness | Energy |
| | D1 | D2 | | (mg/5000 | (mg/5000 | plating in | plating in | retention | swelling | density |
| | (μm) | (μm) | D2/D1 | mm²) | mm²) | flat region | corner region | rate(%) | rate(%) | (Wh/L) |
| Example | 0.3 | 1.2 | 4 | 0.9 | 1.2 | No lithium | No lithium | 94.50 | 8.1 | 755 |
| 1-1 | | | | | | plating | plating | | | |
| Example | 0.5 | 1.2 | 2.4 | 0.9 | 1.2 | No lithium | No lithium | 90.60 | 6.5 | 742 |
| 1-2 | | | | | | plating | plating | | | |
| Example | 0.4 | 1.2 | 3 | 0.9 | 1.2 | No lithium | No lithium | 93.20 | 6.8 | 750 |
| 1-3 | | | | | | plating | plating | | | |
| Example | 0.22 | 1.2 | 5.45 | 0.9 | 1.2 | No lithium | No lithium | 89.20 | 9.8 | 747 |
| 1-4 | | | | | | plating | plating | | | |
| Example | 0.2 | 1.2 | 6 | 0.9 | 1.2 | No lithium | No lithium | 88.20 | 10 | 746 |
| 1-5 | | | | | | plating | plating | | | |
| Example | 0.5 | 1.0 | 2 | 0.9 | 1.2 | No lithium | No lithium | 90.3 | 6.7 | 740 |
| 1-6 | | | | | | plating | plating | | | |
| Example | 0.3 | 1.5 | 5 | 0.9 | 1.2 | No lithium | No lithium | 95 | 7.8 | 748 |
| 1-7 | | | | | | plating | plating | | | |
| Example | 0.14 | 0.8 | 6 | 0.9 | 1.2 | Slight | Slight lithium | 85.60 | 12.3 | 744 |
| 1-8 | | | | | | lithium | plating | | | |
| | | | | | | plating | | | | |
| Example | 0.7 | 1.5 | 2.1 | 0.9 | 1.2 | No lithium | No lithium | 90.50 | 10 | 740 |
| 1-9 | | | | | | plating | plating | | | |
| Example | 0.2 | 0.8 | 4 | 0.9 | 1.2 | No lithium | Slight lithium | 88.70 | 12.4 | 748 |
| 1-10 | | | | | | plating | plating | | | |
| Example | 0.1 | 0.5 | 5 | 0.9 | 1.2 | Slight | Slight lithium | 84.30 | 13.8 | 743 |
| 1-11 | | | | | | lithium | plating | | | |
| | | | | | | plating | | | | |
| Example | 0.9 | 1.8 | 2 | 0.9 | 1.2 | No lithium | No lithium | 87.00 | 14.6 | 738 |
| 1-12 | | | | | | plating | plating | | | |
| Example | 0.3 | 1.2 | 4 | 0.9 | 1 | No lithium | No lithium | 90 | 8.7 | 759 |
| 1-13 | | | | | | plating | plating | | | |
| Example | 0.3 | 1.2 | 4 | 0.9 | 1.1 | No lithium | No lithium | 92.40 | 8.4 | 757 |
| 1-14 | | | | | | plating | plating | | | |
| Example | 0.3 | 1.2 | 4 | 0.9 | 1.3 | No lithium | No lithium | 95.10 | 8.9 | 752 |
| 1-15 | | | | | | plating | plating | | | |
| Example | 0.3 | 1.2 | 4 | 0.9 | 1.5 | No lithium | No lithium | 90.70 | 9.5 | 748 |
| 1-16 | | | | | | plating | plating | | | |
| Example | 0.3 | 1.2 | 4 | 0.9 | 0.9 | No lithium | Slight lithium | 86.50 | 10.6 | 742 |
| 1-17 | | | | | | plating | plating | | | |
| Example | 0.3 | 1.2 | 4 | 0.9 | 1.6 | No lithium | Slight lithium | 88.40 | 10.2 | 738 |
| 1-18 | | | | | | plating | plating | | | |
| Example | 0.3 | 1.2 | 4 | 0.7 | 1 | No lithium | No lithium | 90.80 | 10.1 | 744 |
| 1-19 | | | | | | plating | plating | | | |
| Example | 0.3 | 1.2 | 4 | 1.2 | 1.5 | Slight | No lithium | 88.30 | 12 | 740 |
| 1-20 | | | | | | lithium | plating | | | |
| | | | | | | plating | | | | |
| Comparative | 0.8 | 0.8 | 1 | 0.9 | 1.2 | No lithium | Slight lithium | 80.1 | 16.3 | 752 |
| Example 1 | | | | | | plating | plating | | | |
| Comparative | 0.2 | 1.4 | 7 | 0.9 | 1.2 | No lithium | No lithium | 80.3 | 16.2 | 740 |
| Example 2 | | | | | | plating | plating | | | |
| Comparative | 0.9 | 1.2 | 1.3 | 0.9 | 1.2 | No lithium | No lithium | 88.2 | 15.3 | 736 |
| Example 3 | | | | | | plating | plating | | | |
| Comparative | 0.3 | 0.3 | 1 | 0.9 | 1.2 | No lithium | Severe | 76.1 | 24.1 | 736 |
| Example 4 | | | | | | plating | lithium | | | |
| | | | | | | | plating black | | | |
| | | | | | | | spots | | | |
| Comparative | 0.9 | 0.3 | 0.3 | 0.9 | 1.2 | No lithium | Severe | 80.5 | 18.4 | 734 |
| Example 5 | | | | | | plating | lithium | | | |
| | | | | | | | plating black | | | |
| | | | | | | | spots | | | |

From Examples 1-1 to 1-20 and Comparative Examples 1-1 to 1-5, it can be seen that in the examples, when the relationship between D1 and D2 satisfies 2≤D2/D1≤6, the resulting lithium-ion batteries have no severe lithium plating or black spots in both the flat region and corner region, and have higher cycle capacity retention rate and lower cycle thickness swelling rate, while maintaining kinetic performance and energy density. Although Comparative Example 1 has no severe lithium plating phenomenon, due to the excessively large average short-axis size D1 of the particles of the first coating region coating material, the bonding force is poorer under the same coating weight, and D2/D1<2. Therefore, the resulting lithium-ion battery has low cycle capacity retention rate and high cycle thickness swelling rate. In Comparative Example 2, the average short-axis size D2 along the thickness direction of the bonding layer in the second coating region material is too large, leading to D2/D1>6, resulting in excessively long ion transmission paths in the corner region, increased internal resistance, thereby reducing the cycle capacity retention rate of the lithium-ion battery, and gas swelling occurs, the cycle thickness swelling rate is large, and the volume of the corner region increases, impairing energy density. In Comparative Example 3, the average short-axis size D1 of the particles of the first coating region material is too large, leading to D2/D1<2, the resulting lithium-ion battery has larger thickness, low energy density, and poor bonding in the first coating region. Thus, the resulting lithium-ion battery has low cycle capacity retention rate and high cycle thickness swelling rate. In Comparative Example 4, the average short-axis size D2 of the particles of the second coating region material is too small, leading to D2/D1<2, too small D2 leads to insufficient electrolyte storage in the corner region, severe lithium plating occurs, and the resulting lithium-ion battery has poor cycling performance and high thickness change rate. In Comparative Example 5, the average short-axis size D1 of the particles of the first coating region material is too large, and the average short-axis size D2 of the particles of the second coating region material is too small, leading to D2/D1<2, too small D2 leads to insufficient electrolyte storage in the corner region, severe lithium plating occurs, while too large D1 makes the viscosity in the flat region insufficient, thereby the resulting lithium-ion battery has poor cycle capacity retention rate and high cycle thickness swelling rate. Thus, it shows that the lithium-ion battery satisfying the present application has improved electrolyte storage capacity in the corner region, while the flat region still has good ion transmission rate, the viscosity between the negative electrode sheet and the separator is moderate, no severe lithium plating occurs in both the flat region and corner region, the lithium-ion battery has good cycling performance and kinetic performance, and maintains the energy density.

The coating weight b of the second coating region usually affects the kinetic performance, cycling performance, and energy density of the lithium-ion battery. From Examples 1-1 and 1-13 to 1-18, it can be seen that when the coating weight b of the second coating region is within the range of the present application, there is no lithium plating phenomenon in the corner region, and the resulting lithium-ion battery has higher cycle capacity retention rate, lower cycle thickness swelling rate, and higher energy density. Thus, it shows that when the coating weight b of the second coating region is within the range of the present application, the resulting lithium-ion battery has better cycling performance and kinetic performance, and balances energy density.

The coating weight a of the first coating region usually affects the kinetic performance, cycling performance, and energy density of the lithium-ion battery. From Examples 1-1 and 1-19 to 1-20, it can be seen that when the coating weight a of the first coating region is within the range of the present application, there is no severe lithium plating phenomenon in the flat region, and the resulting lithium-ion battery has higher cycle capacity retention rate, lower cycle thickness swelling rate, and higher energy density. Thus, it shows that when the coating weight a of the first coating region is within the range of the present application, the resulting lithium-ion battery has better cycling performance and kinetic performance, and balances energy density.

TABLE 2

| | | | | | | | | | Cycle | Cycle | |
|---|---|---|---|---|---|---|---|---|---|---|---|
| | | | | | | | Lithium | Lithium | capacity | thickness | Energy |
| | First | Second | Third | Fourth | | | plating in | plating in | retention | swelling | density |
| | binder | binder | binder | binder | m1 | m2 | flat region | corner region | rate(%) | rate(%) | (Wh/L) |
| Example | Methyl | Styrene | Methyl | Styrene | 1:1.5 | 1:2.7 | No lithium | No lithium | 94.50 | 8.1 | 755 |
| 1-1 | acrylate | | acrylate | | | | plating | plating | | | |
| Example | Methyl | Styrene | Methyl | Styrene | 1:1.2 | 1:2.7 | No lithium | No lithium | 93.30 | 8.5 | 750 |
| 1-21 | acrylate | | acrylate | | | | plating | plating | | | |
| Example | Methyl | Styrene | Methyl | Styrene | 1:2.0 | 1:2.7 | No lithium | No lithium | 92 | 9.5 | 758 |
| 1-22 | acrylate | | acrylate | | | | plating | plating | | | |
| Example | Methyl | Styrene | Methyl | Styrene | 1:1 | 1:2.7 | Slight | No lithium | 86.80 | 14 | 741 |
| 1-23 | acrylate | | acrylate | | | | lithium | plating | | | |
| | | | | | | | plating | | | | |
| Example | Methyl | Styrene | Methyl | Styrene | 1:3 | 1:2.7 | No lithium | No lithium | 86.10 | 14.5 | 740 |
| 1-24 | acrylate | | acrylate | | | | plating | plating | | | |
| Example | Methyl | Styrene | Methyl | Styrene | 1:1.5 | 1:1.5 | No lithium | No lithium | 92.30 | 9.8 | 750 |
| 1-25 | acrylate | | acrylate | | | | plating | plating | | | |
| Example | Methyl | Styrene | Methyl | Styrene | 1:1.5 | 1:4 | No lithium | No lithium | 91.3 | 10.5 | 746 |
| 1-26 | acrylate | | acrylate | | | | plating | plating | | | |
| Example | Methyl | Styrene | Methyl | Styrene | 1:1.5 | 1:1 | No lithium | Slight lithium | 88.30 | 14 | 740 |
| 1-27 | acrylate | | acrylate | | | | plating | plating | | | |
| Example | Methyl | Styrene | Methyl | Styrene | 1:1.5 | 1:5 | No lithium | No lithium | 87.60 | 14.8 | 738 |
| 1-28 | acrylate | | acrylate | | | | plating | plating | | | |
| Example | Octyl | Acrylonitrile | Methyl | Styrene | 1:1.5 | 1:2.7 | No lithium | No lithium | 94.30 | 8.2 | 748 |
| 1-29 | acrylate | | acrylate | | | | plating | plating | | | |
| Example | Octyl | Acrylonitrile | Octyl | Acrylonitrile | 1:1.5 | 1:2.7 | No lithium | No lithium | 94.60 | 8.3 | 750 |
| 1-30 | acrylate | | acrylate | | | | plating | plating | | | |

The mass ratio m1 of the first binder material to the second binder material usually affects the kinetic performance, cycling performance, and energy density of the lithium-ion battery. From Examples 1-1 and 1-21 to 1-24, it can be seen that when the mass ratio m1 of the first binder material to the second binder material is within the range of the present application, there is no severe lithium plating phenomenon in both the flat region and corner region, and the resulting lithium-ion battery has higher cycle capacity retention rate, lower cycle thickness swelling rate, and higher energy density. Thus, it shows that when the mass ratio m1 of the first binder material to the second binder material is within the range of the present application, the resulting lithium-ion battery has better cycling performance and kinetic performance, and maintains the energy density.

The mass ratio m2 of the third binder material to the fourth binder material usually affects the kinetic performance, cycling performance, and energy density of the lithium-ion battery. From Examples 1-1 and 1-25 to 1-28, it can be seen that when the mass ratio m2 of the third binder material to the fourth binder material is within the range of the present application, there is no severe lithium plating phenomenon in both the flat region and corner region, and the resulting lithium-ion battery has higher cycle capacity retention rate, lower cycle thickness swelling rate, and higher energy density. Thus, it shows that when the mass ratio m2 of the third binder material to the fourth binder material is within the range of the present application, the resulting lithium-ion battery has better cycling performance and kinetic performance, and maintains the energy density.

The types of the first binder material, third binder material and the second binder material, fourth binder material usually affect the kinetic performance, cycling performance, and energy density of the lithium-ion battery. From Examples 1-1, 1-29 and 1-30, it can be seen that when the types of the first binder material, third binder material and the second binder material, fourth binder material are within the range of the present application, there is no severe lithium plating phenomenon in both the flat region and corner region, and the resulting lithium-ion battery has higher cycle capacity retention rate, lower cycle thickness swelling rate, and higher energy density. Thus, it shows that when the types of the first binder material, third binder material and the second binder material, fourth binder material are within the ranges of the present application, the resulting lithium-ion battery has better cycling performance and kinetic performance, and maintains the energy density.

TABLE 3

| | | | | | | Mass | Mass | | | | | |
|---|---|---|---|---|---|---|---|---|---|---|---|---|
| | | | | | Mass | percent- | percentage | Lithium | Lithium | Cycle | | |
| | | | Type | | percentage | age | of | plating | plating | capacity | Cycle | |
| | Solid | | of | | of | of | wetting | in | in | reten- | thickness | Energy |
| | electrolyte | W1 | ceramic | W2 | dispersant | binder | agent | flat | corner | tion | swelling | density |
| | type | (%) | material | (%) | (%) | (%) | (%) | region | region | rate(%) | rate(%) | (Wh/L) |
| Example | / | 0 | Boehmite | 92 | 0.8 | 6 | 1.2 | No lithium | No lithium | 94.50 | 8 | 755 |
| 1-1 | | | | | | | | plating | plating | | | |
| Example | Li_{1.5}Al_{0.5}Ti_{1.5}(PO₄)₃ | 5 | Boehmite | 85.8 | 0.7 | 7 | 1.5 | No lithium | No lithium | 96.2 | 7.2 | 765 |
| 2-1 | | | | | | | | plating | plating | | | |
| Example | Li_{1.5}Al_{0.5}Ti_{1.5}(PO₄)₃ | 1 | Boehmite | 89.8 | 0.7 | 7 | 1.5 | No lithium | No lithium | 92.30 | 10.8 | 757 |
| 2-2 | | | | | | | | plating | plating | | | |
| Example | Li_{1.5}Al_{0.5}Ti_{1.5}(PO₄)₃ | 3 | Boehmite | 87.8 | 0.7 | 7 | 1.5 | No lithium | No lithium | 94 | 8 | 760 |
| 2-3 | | | | | | | | plating | plating | | | |
| Example | Li_{1.5}Al_{0.5}Ti_{1.5}(PO₄)₃ | 6 | Boehmite | 84.8 | 0.7 | 7 | 1.5 | No lithium | No lithium | 95.70 | 7.8 | 762 |
| 2-4 | | | | | | | | plating | plating | | | |
| Example | Li_{1.5}Al_{0.5}Ti_{1.5}(PO₄)₃ | 8 | Boehmite | 82.8 | 0.7 | 7 | 1.5 | No lithium | No lithium | 92.50 | 10.5 | 760 |
| 2-5 | | | | | | | | plating | plating | | | |
| Example | Li_{1.5}Al_{0.5}Ti_{1.5}(PO₄)₃ | 9 | Boehmite | 81.8 | 0.7 | 7 | 1.5 | No lithium | Slight | 88 | 14 | 750 |
| 2-6 | | | | | | | | plating | lithium | | | |
| | | | | | | | | | plating | | | |
| Example | Li_{1.5}Al_{0.5}Ti_{1.5}(PO₄)₃ | 8 | Boehmite | 78 | 1 | 10 | 3 | Slight | Slight | 85 | 15 | 745 |
| 2-7 | | | | | | | | lithium | lithium | | | |
| | | | | | | | | plating | plating | | | |
| Example | Li_{1.5}Al_{0.5}Ti_{1.5}(PO₄)₃ | 1 | Boehmite | 92 | 0.7 | 5 | 1.3 | No lithium | No lithium | 92 | 8.50 | 756 |
| 2-8 | | | | | | | | plating | plating | | | |
| Example | Li₆ZrTi₃O₁₂ | 5 | Magnesium | 85.8 | 0.7 | 7 | 1.5 | No lithium | No lithium | 95.80 | 7.3 | 758 |
| 2-9 | | | hydroxide | | | | | plating | plating | | | |

“/” in Table 3 indicates that the relevant parameter does not exist.

The mass percentages of ceramic material and solid electrolyte in the composite layer usually affect the kinetic performance, cycling performance, and energy density of the lithium-ion battery. From Examples 1-1 and 2-1 to 2-8, it can be seen that when the mass percentages of ceramic material and solid electrolyte in the composite layer are within the ranges of the present application, there is no severe lithium plating phenomenon in both the flat region and corner region, and the resulting lithium-ion battery has higher cycle capacity retention rate, lower cycle thickness swelling rate, and higher energy density. Thus, it shows that when the mass percentages of ceramic material and solid electrolyte in the composite layer are within the ranges of the present application, the resulting lithium-ion battery has better cycling performance and kinetic performance, and maintains the energy density.

The types of ceramic material and solid electrolyte in the composite layer usually affect the kinetic performance, cycling performance, and energy density of the lithium-ion battery. From Examples 2-1, 2-8 and 2-9, it can be seen that when the types of ceramic material and solid electrolyte in the composite layer are within the ranges of the present application, there is no severe lithium plating phenomenon in both the flat region and corner region, and the resulting lithium-ion battery has higher cycle capacity retention rate, lower cycle thickness swelling rate, and higher energy density. Thus, it shows that when the types of ceramic material and solid electrolyte in the composite layer are within the ranges of the present application, the resulting lithium-ion battery has better cycling performance and kinetic performance, and maintains the energy density.

TABLE 4

| | | | | | | | Cycle | Cycle | |
|---|---|---|---|---|---|---|---|---|---|
| | | | c | d | Lithium | Lithium | capacity | thickness | Energy |
| | D3 | D4 | (mg/5000 | (mg/5000 | plating in flat | plating in | retention | swelling | density |
| | (nm) | (nm) | mm²) | mm²) | region | corner region | rate(%) | rate(%) | (Wh/L) |
| Example | 350 | 700 | 10 | 11 | No lithium | No lithium | 96.2 | 7.2 | 765 |
| 2-1 | | | | | plating | plating | | | |
| Example | 200 | 700 | 10 | 11 | Slight lithium | No lithium | 93.90 | 8.3 | 758 |
| 2-10 | | | | | plating | plating | | | |
| Example | 300 | 700 | 10 | 11 | No lithium | No lithium | 95.30 | 7.8 | 760 |
| 2-11 | | | | | plating | plating | | | |
| Example | 400 | 700 | 10 | 11 | No lithium | No lithium | 95.80 | 7.7 | 758 |
| 2-12 | | | | | plating | plating | | | |
| Example | 500 | 700 | 10 | 11 | No lithium | No lithium | 94.10 | 8.7 | 754 |
| 2-13 | | | | | plating | plating | | | |
| Example | 100 | 700 | 10 | 11 | Slight lithium | No lithium | 87.70 | 11.5 | 758 |
| 2-14 | | | | | plating | plating | | | |
| Example | 600 | 700 | 10 | 11 | No lithium | No lithium | 86.80 | 11.9 | 742 |
| 2-15 | | | | | plating | plating | | | |
| Example | 350 | 600 | 10 | 11 | No lithium | Slight lithium | 92.80 | 8.5 | 758 |
| 2-16 | | | | | plating | plating | | | |
| Example | 350 | 650 | 10 | 11 | No lithium | No lithium | 95.20 | 7.7 | 760 |
| 2-17 | | | | | plating | plating | | | |
| Example | 350 | 750 | 10 | 11 | No lithium | No lithium | 95.70 | 7.5 | 760 |
| 2-18 | | | | | plating | plating | | | |
| Example | 350 | 800 | 10 | 11 | No lithium | No lithium | 93.30 | 8.9 | 750 |
| 2-19 | | | | | plating | plating | | | |
| Example | 350 | 500 | 10 | 11 | No lithium | Slight lithium | 90.10 | 11.7 | 752 |
| 2-20 | | | | | plating | plating | | | |
| Example | 350 | 900 | 10 | 11 | No lithium | No lithium | 85.90 | 11.8 | 742 |
| 2-21 | | | | | plating | plating | | | |
| Example | 350 | 700 | 10 | 10.1 | No lithium | Slight lithium | 92.2 | 8.50 | 750 |
| 2-22 | | | | | plating | plating | | | |
| Example | 350 | 700 | 10 | 10.4 | No lithium | No lithium | 92.6 | 8.20 | 755 |
| 2-23 | | | | | plating | plating | | | |
| Example | 350 | 700 | 10 | 11.2 | No lithium | No lithium | 94.2 | 7.5 | 760 |
| 2-24 | | | | | plating | plating | | | |
| Example | 350 | 700 | 10 | 12 | No lithium | Slight lithium | 91.7 | 8.6 | 755 |
| 2-25 | | | | | plating | plating | | | |
| Example | 350 | 700 | 10 | 13 | No lithium | Slight lithium | 86.8 | 11.0 | 748 |
| 2-26 | | | | | plating | plating | | | |
| Example | 350 | 700 | 7 | 8 | No lithium | No lithium | 95.6 | 8.3 | 755 |
| 2-27 | | | | | plating | plating | | | |
| Example | 350 | 700 | 12 | 13 | No lithium | No lithium | 95.1 | 8.8 | 740 |
| 2-28 | | | | | plating | plating | | | |

The average particle size D3 of the ceramic material in the third coating region usually affects the kinetic performance, cycling performance, and energy density of the lithium-ion battery. From Examples 2-1 and 2-10 to 2-15, it can be seen that when the average particle size D3 of the ceramic material in the third coating region is within the range of the present application, there is no severe lithium plating phenomenon in both the flat region and corner region, and the resulting lithium-ion battery has higher cycle capacity retention rate, lower cycle thickness swelling rate, and higher energy density. Thus, it shows that when the average particle size D3 of the ceramic material in the third coating region is within the range of the present application, the resulting lithium-ion battery has better cycling performance and kinetic performance, and maintains the energy density.

The average particle size D4 of the ceramic material in the fourth coating region usually affects the kinetic performance, cycling performance, and energy density of the lithium-ion battery. From Examples 2-1 and 2-16 to 2-21, it can be seen that when the average particle size D4 of the ceramic material in the fourth coating region is within the range of the present application, there is no severe lithium plating phenomenon in both the flat region and corner region, and the resulting lithium-ion battery has higher cycle capacity retention rate, lower cycle thickness swelling rate, and higher energy density. Thus, it shows that when the average particle size D4 of the ceramic material in the fourth coating region is within the range of the present application, the resulting lithium-ion battery has better cycling performance and kinetic performance, and maintains the energy density.

The coating weight of the third coating region usually affects the kinetic performance, cycling performance, and energy density of the lithium-ion battery. From Examples 2-1, 2-27, and 2-28, it can be seen that when the coating weight of the third coating region is within the range of the present application, there is no severe lithium plating phenomenon in both the flat region and corner region, and the resulting lithium-ion battery has higher cycle capacity retention rate, lower cycle thickness swelling rate, and higher energy density. When the coating weight of the third coating region is low, such as Example 2-27, the mechanical strength and heat shrinkage resistance of the resulting separator are low, which will affect the safety performance of the lithium-ion battery. Thus, it shows that when the coating weight of the third coating region is within the range of the present application, the resulting lithium-ion battery has better cycling performance and kinetic performance, and maintains the energy density.

The coating weight of the fourth coating region usually affects the kinetic performance, cycling performance, and energy density of the lithium-ion battery. From Examples 2-1 and 2-22 to 2-26, it can be seen that when the coating weight of the fourth coating region is within the range of the present application, there is no severe lithium plating phenomenon in both the flat region and corner region, and the resulting lithium-ion battery has higher cycle capacity retention rate, lower cycle thickness swelling rate, and higher energy density. Thus, it shows that when the coating weight of the fourth coating region is within the range of the present application, the resulting lithium-ion battery has better cycling performance and kinetic performance, and maintains the energy density.

It should be noted that in this document, relational terms such as first and second are only used to distinguish one entity or operation from another entity or operation, and do not necessarily require or imply any such actual relationship or order between these entities or operations. Moreover, the terms “comprise”, “include” or any other variations thereof are intended to cover non-exclusive inclusion, so that a process, method or article that includes a series of elements not only includes those elements, but also includes other elements not explicitly listed, or also includes elements inherent to such process, method or article.

The various embodiments in this specification are described in a related manner, and the same and similar parts between the various embodiments can be referred to each other, and each embodiment focuses on the differences from other embodiments.

The above are only preferred embodiments of the present application and are not intended to limit the present application. Any modifications, equivalent replacements, improvements, and the like made within the spirit and principles of the present application should be included within the protection scope of the present application.

What is claimed is:

1. A secondary battery, comprising an electrode assembly with a wound structure, wherein the electrode assembly comprises a negative electrode sheet and a separator; the negative electrode sheet comprises a negative electrode current collector, a negative electrode material layer, and a bonding layer; and along a thickness direction of the negative electrode sheet, the negative electrode material layer is located between the negative electrode current collector and the bonding layer;
the bonding layer comprises a first coating region and a second coating region, wherein the first coating region is located in a flat region of the electrode assembly, the second coating region is located in a corner region of the electrode assembly, which is a curved region of the electrode assembly; the first coating region comprises a first coating region material, and the second coating region comprises a second coating region material; and
in a cross-section of the bonding layer along a thickness direction of the bonding layer, an average short-axis size of particles of the first coating region material is D1 μm, an average short-axis size of particles of the second coating region material is D2 μm, and 2≤D2/D1≤6.

2. The secondary battery according to claim 1, wherein 0.14≤D1≤0.7, 0.8≤D2≤1.5.

3. The secondary battery according to claim 1, wherein the secondary battery satisfies at least one of the following features:
$$3 \leq D 2 / D 1 \leq 5 ; \qquad ( 1 )$$
$$0.2 \leq D 1 \leq 0.5 ; or \qquad ( 2 )$$
$$1 \leq D 2 \leq 1.2 . \qquad ( 3 )$$

4. The secondary battery according to claim 1, wherein a coating weight of the first coating region is a mg/5000 mm², a coating weight of the second coating region is b mg/5000 mm², and (a+0.1)≤b≤(a+0.6).

5. The secondary battery according to claim 4, wherein (a+0.2)≤b≤(a+0.4).

6. The secondary battery according to claim 4, wherein 0.7≤a≤1.2.

7. The secondary battery according to claim 1, wherein the first coating region material comprises a first binder material and a second binder material, and the second coating region material comprises a third binder material and a fourth binder material; wherein
the first binder material and the third binder material each independently comprise at least one of methyl acrylate, octyl acrylate, polymethyl methacrylate, or isooctyl acrylate; and the second binder material and the fourth binder material each independently comprise at least one of styrene, acrylonitrile, or polyvinylidene fluoride;
a mass ratio m1 of the first binder material to the second binder material is 1:(1.2 to 2.0); and
a mass ratio m2 of the third binder material to the fourth binder material is 1:(1.5 to 4).

8. The secondary battery according to claim 1, wherein the separator comprises a base film and a composite layer disposed on one surface of the base film, wherein the composite layer faces the negative electrode sheet, the composite layer comprises a ceramic material; and based on a mass of the composite layer, a mass percentage of the ceramic material is W2, and 78%≤W2≤92%.

9. The secondary battery according to claim 8, wherein the composite layer further comprises a solid electrolyte; wherein, based on the mass of the composite layer, a mass percentage of the solid electrolyte is W1, and 1%≤W1≤8%.

10. The secondary battery according to claim 9, wherein 3%≤W1≤6%.

11. The secondary battery according to claim 8, wherein the composite layer comprises a third coating region and a fourth coating region, wherein the third coating region is located in the flat region of the electrode assembly, the fourth coating region is located in the corner region of the electrode assembly, which is a curved region of the electrode assembly; an average particle size of the ceramic material in the third coating region is D3 nm, an average particle size of the ceramic material in the fourth coating region is D4 nm, 200≤D3≤500, and 600≤D4≤800.

12. The secondary battery according to claim 11, wherein the secondary battery satisfies at least one of the following features:
$$300 \leq D 3 \leq 400 ; or \qquad ( 1 )$$
$$650 \leq D 4 \leq 750 . \qquad ( 2 )$$

13. The secondary battery according to claim 11, wherein a coating weight of the third coating region is c mg/5000 mm², a coating weight of the fourth coating region is d mg/5000 mm², and (c+0.1)≤d≤(c+2).

14. The secondary battery according to claim 13, wherein (c+0.4)≤d≤(c+1.2).

15. The secondary battery according to claim 13, wherein 7≤c≤12.

16. The secondary battery according to claim 9, wherein the secondary battery satisfies at least one of the following features:
(1) the solid electrolyte comprises at least one of lithium aluminum titanium phosphate, lithium lanthanum zirconium oxide, lithium lanthanum zirconium titanium oxide, or lithium lanthanum titanium oxide; or
(2) the ceramic material comprises at least one of boehmite, alumina, magnesium hydroxide, or barium sulfate.

17. An electronic device, comprising a secondary battery, wherein the secondary battery comprises an electrode assembly with a wound structure, wherein the electrode assembly comprises a negative electrode sheet and a separator, the negative electrode sheet comprises a negative electrode current collector, a negative electrode material layer, and a bonding layer; and along a thickness direction of the negative electrode sheet, the negative electrode material layer is located between the negative electrode current collector and the bonding layer;
the bonding layer comprises a first coating region and a second coating region, wherein the first coating region is located in a flat region of the electrode assembly, the second coating region is located in a corner region of the electrode assembly, which is a curved region of the electrode assembly; the first coating region comprises a first coating region material, and the second coating region comprises a second coating region material; and
in a cross-section of the bonding layer along a thickness direction of the bonding layer, an average short-axis size of particles of the first coating region material is D1 μm, an average short-axis size of particles of the second coating region material is D2 μm, and 2≤D2/D1≤6.

18. The electronic device according to claim 17, wherein 0.14≤D1≤0.7, 0.8≤D2≤1.5.

19. The electronic device according to claim 17, wherein the secondary battery satisfies at least one of the following features:
$$3 \leq D 2 / D 1 \leq 5 ; \qquad ( 1 )$$
$$0.2 \leq D 1 \leq 0.5 ; or \qquad ( 2 )$$
$$1 \leq D 2 \leq 1.2 . \qquad ( 3 )$$

20. The electronic device according to claim 17, wherein a coating weight of the first coating region is a mg/5000 mm², a coating weight of the second coating region is b mg/5000 mm², and (a+0.1)≤b≤(a+0.6).
